(19) United States
(12) Patent Application Publication
(10) Pub. No.: US 2014/0027220 A1
(43) Pub. Date: Jan. 30, 2014

(54) Separating Piston

(71) Applicants: Günther HANDKE, Euerbach (DE); Thomas Thein, Sennfeld (DE); Hassan Asadi, Scheinfurt (DE)

(72) Inventors: Günther HANDKE, Euerbach (DE); Thomas Thein, Sennfeld (DE); Hassan Asadi, Scheinfurt (DE)

(21) Appl. No.: 13/950,367

(22) Filed: Jul. 25, 2013

(30) Foreign Application Priority Data
Jul. 27, 2012 (DE) 10 2012 213 272.4

(51) Int. Cl. F16F 9/32

(52) U.S. Cl. CPC F16F 9/3214
USPC 188/322.22

(57) ABSTRACT

A separating piston for hydropneumatic units, separating a cylinder interior which is filled with liquid in a cylinder from a gas-filled compensation chamber or spring space in a sealing manner and which is formed of two parts and has a radially circumferential seal groove in which is arranged an annular seal which can tightly contact the inner wall of the cylinder. One of the two separating piston parts is a guide part which has characteristics conducive to sliding and which slides at the inner wall of the cylinder, and the other separating piston part is a retaining part which is connected to the guide part. The guide part is a stamped and/or bent sheet metal part which is coated with a guide or running layer at least on its guide area sliding along the inner wall of the cylinder.

### BACKGROUND OF THE INVENTION

1. Field of the Invention

The present invention is directed to a separating piston for hydropneumatic units, separating a cylinder interior filled with liquid in a cylinder from a gas-filled compensation chamber or spring space in a sealing manner and which is formed of two parts and has a radially circumferential seal groove in which is arranged an annular seal which can tightly contact the inner wall of the cylinder, wherein one of the two separating piston parts is a guide part which has characteristics conducive to sliding and which slides at the inner wall of the cylinder, and the other separating piston part is a retaining part which is connected to the guide part.

2. Description of the Related Art

In separating pistons of the type mentioned above, it is known to produce the guide part and retaining part as sheet metal parts. In order to keep frictional resistance as small as possible during sliding of the separating piston in the cylinder, it is known to carry out finishing of the surfaces of the guide part which slide along the inner wall of the cylinder. This makes production of the separating piston cumbersome and expensive.

Therefore, it is an object of the invention to provide a separating piston of the type mentioned above which can be produced in a simple and inexpensive manner and which need only overcome slight frictional resistance when sliding in the cylinder.

### SUMMARY OF THE INVENTION

This object is met according to the invention in that the guide part is a stamped and/or bent sheet metal part which is coated with a running layer at least on its guide area sliding at the inner wall of the cylinder.

Producing as a stamped and/or bent part and coating with a single guide or running layer allows an economical production with smooth sliding of the separating piston in the cylinder.

The separating piston can be applied, e.g., in vibration dampers, suspension struts, hydraulically damped gas springs, or cylindrical pressure accumulators.

The guide part can be made of steel or bronze, and the guide or running layer can be a plastic layer which can be applied to the guide part in a simple and inexpensive manner.

When the running layer is formed of PTFE (polytetrafluoroethylene) or contains PTFE, this layer can already be applied in an efficient manner to the sheet metal before it has been shaped and is then compulsorily shaped along with the shaping of the guide part.

The running layer can be formed of a mixture of PTFE (polytetrafluoroethylene) and Pb (lead).

The running layer which is formed of or contains PTFE has a high quality for a dry self-lubrication and, therefore, has low friction at the inner wall of the cylinder. Further, its low wear leads to good durability characteristics.

In a simple manner, the running layer can be applied to a metal plate and the guide part can be shaped subsequently by a stamping and/or bending process.

If the seal groove is formed in its entirety or partially in the guide part, they need not be produced separately.

In a simple and economical manner, the retaining part can also be a stamped and/or bent part formed from sheet metal.

When the retaining part is made of plastic, weight is additionally reduced. The retaining part can also be produced inexpensively when the retaining part is a plastic injection molded part.

The guide part or retaining part can have a receptacle for connecting to the retaining part or guide part.

No separate connection elements are required to connect these parts when the guide part and retaining part can be connected to one another by positive engagement and/or frictional engagement. This also simplifies and economizes the stocking or logistics of the parts of the separating piston.

The parts of the separating piston can be connected in a simple manner in that the receptacle is a rotationally symmetrical receptacle opening of the guide part which is coaxial to the longitudinal axis of the separating piston and into which a corresponding receptacle projection of the retaining part can be inserted.

It is also possible that the receptacle is a rotationally symmetrical receptacle projection of the guide part which is coaxial to the longitudinal axis of the separating piston and into which a corresponding receptacle opening of the retaining part can be inserted.

To maintain the connection of the guide part and retaining part and to produce this connection in a simple manner, the receptacle projection can be inserted into the receptacle opening with an interference fit.

To ensure the correct assembly position of the guide part and retaining part in a simple manner during assembly, the receptacle projection of the retaining part or of the guide part can be inserted into the receptacle opening until it abuts at a stop of the guide part or of the retaining part.

The seal groove can be formed in its entirety or partially in the retaining part. It is also possible that the retaining part has a radially circumferential flange forming a side wall of the seal groove.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An embodiment of the invention is described more fully in the following and shown in the drawings in which:

FIG. 1 is a longitudinal sectional view of a mono-tube shock absorber of the present invention;

FIG. 2 is a view of first embodiment of a separating piston of the mono-tube shock absorber according to FIG. 1 in cross section;

FIG. 3 is a view of second embodiment of a separating piston of the mono-tube shock absorber according to FIG. 1 in cross section;

FIG. 4 a view of third embodiment of a separating piston of the mono-tube shock absorber according to FIG. 1 in cross section.

### DETAILED DESCRIPTION OF THE PRESENTLY PREFERRED EMBODIMENTS

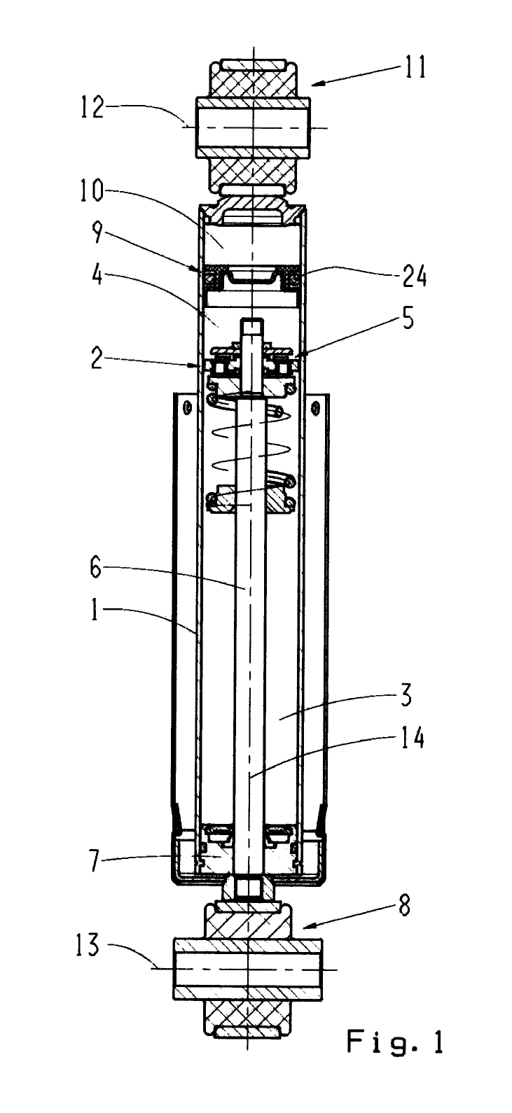

The hydraulic mono-tube shock absorber of a vehicle shown in FIG. 1 has a cylinder 1 in which a damping piston 2 is guided so as to be axially displaceable. The cylinder 1 is divided by the damping piston 2 into a first working chamber 3 and a second working chamber 4. The two working chambers 3 and 4 are filled with a damping liquid.

Arranged in the damping piston 2 are throttle valves 5 through which damping liquid can flow from the first working chamber 3 to the second working chamber 4, and vice versa, during the movement of the damping piston 2.

The damping piston has a piston rod 6 on one side, which piston rod 6 is guided through the first working chamber 3 and through a guiding and sealing unit 7 out of the first working chamber 3 in a sealed manner. The piston rod 6 has a first knuckle eye 8 at its free end that is guided out of the cylinder 1.

On the side of the damping piston 2 opposite the piston rod 6, a separating piston 9 is displaceably arranged in the cylinder 1 and separates the second working chamber 4 from a compensation chamber 10 which is formed between the separating piston 9 and the closed end of the cylinder 1. The compensation chamber 10 is filled with a gas under pre-pressure.

A second knuckle eye 11 is arranged at the closed end of the cylinder 1 opposite the first knuckle eye 8. The mutually parallel joint axes 12 and 13 of the knuckle eyes 8 and 11 extend transverse to the longitudinal axis 14 of the cylinder 1 and axial to a wheel axle, not shown, of the vehicle.

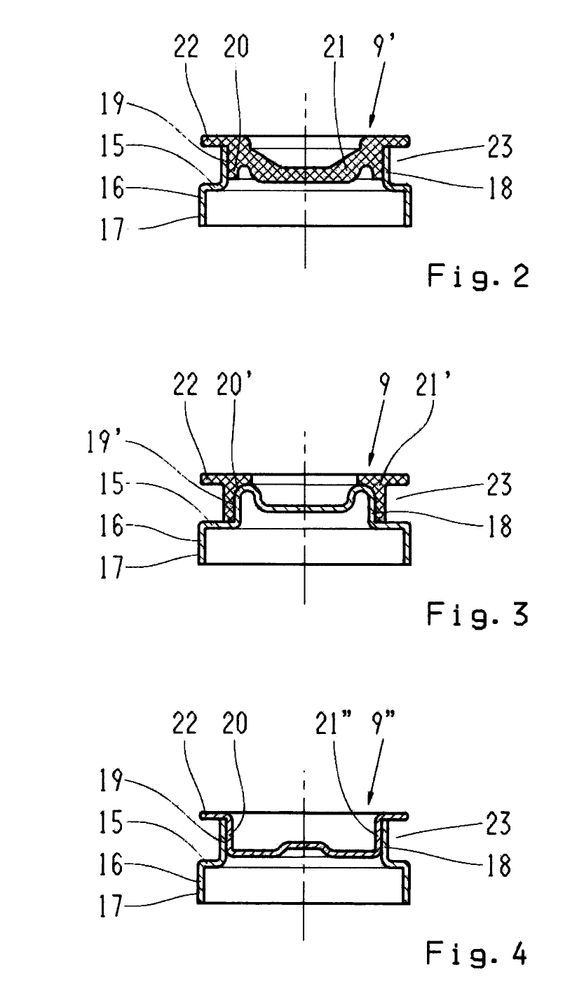

The separating piston 9′ shown in FIG. 2 has, as stamped and/or bent part, a rotationally symmetrical guide part 15 which is produced from sheet bronze. The guide area 16 of the guide part 15 by which the separating piston 9′ is displaceably guided in the cylinder 1 is coated at its outer side with a guide or running layer 17 formed of a mixture of PTFE and Pb.

Adjoining the guide area 16 axially at one side is a tubular connection region 18 which has a smaller diameter than the guide area 16, its inner passage forming a receptacle opening 19.

A corresponding receptacle projection 20 of a retaining part 21 made of plastic is pressed into the receptacle opening 19.

The retaining part 21 has at its side remote of the guide part 15 a radially circumferential flange 22 which contacts the front end of the guide part 15 and forms a side wall of a radially circumferential seal groove 23 for receiving an annular seal 24. The base and the other side wall of the seal groove 23 are formed by the tubular connection region 18 of the smaller diameter of the guide part 15.

The embodiment example of the separating piston 9 in FIG. 3 corresponds to the separating piston 9 shown in FIG. 1.

This separating piston 9 likewise has, as stamped and/or bent part, a rotationally symmetrical guide part 15 which is produced from sheet bronze. The guide area 16 of the guide part 15, by which the separating piston 9′ is displaceably guided in the cylinder 1, is coated at its outer side with a guide or running layer 17 formed of a mixture of PTFE and Pb.

Adjoining the guide area 16 axially at one side is a tubular connection region 18 which has a smaller diameter than the guide area 16, but is closed and has no inner passage.

The tubular connection region 18 forms a rotationally symmetrical receptacle projection 20′. A corresponding receptacle opening 19′ of a rotationally symmetrical retaining part 21′ encircling the receptacle projection 20′ is pressed onto the outer side of the receptacle projection 20′. The retaining part 21′ is a plastic part which has an outer cylindrical surface at its area encircling the receptacle projection 20′ and a radially circumferential flange 22 at its side remote of the guide part 15.

This flange 22 forms the one side wall of a radially circumferential seal groove 23 for receiving an annular seal 24. The base of the seal groove 23 is formed by the outer cylindrical surface of the region of the retaining part 21′ encircling the receptacle projection 20, while the other side wall of the seal groove 23 is formed by the region of the guide part 15 leading radially from the guide area 16 to the receptacle projection 20′.

The separating piston 9″ according to FIG. 4 has a guide part 15 corresponding to the guide part 15 in FIG. 2. Also, the retaining part 21″ corresponds with respect to construction to the retaining part 21 from FIG. 2 with the difference that it is not made of plastic but rather is a stamped and bent part produced from sheet metal.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A separating piston for sealingly separating a liquid from a gas-filled compensation chamber in the interior space of a cylinder of a hydropneumatic unit, said separating piston comprising:
a guide part constructed from one of a stamped and bent sheet metal part, having a guide area for sliding along an inner wall of the cylinder, said guide part having a guide area;
a retaining part connected to said guide part;
said guide part and said retaining part forming a radially circumferential seal groove;
an annular seal disposed within said seal groove and sealingly contacting an inner wall of said cylinder; and
a running layer disposed at least on said guide area of said guide part for permitting said separating piston to slide along the inner wall of said cylinder.

2. The separating piston according to claim 1, wherein said guide part is made of one of steel and bronze.

3. The separating piston according to claim 1, wherein said the running layer is one of formed of PTFE (polytetrafluoroethylene) and contains PTFE.

4. The separating piston according to claim 1, wherein said seal groove is formed at least partially in said guide part.

5. The separating piston according to claim 1, wherein said retaining part is one of a stamped and bent part formed from sheet metal.

6. The separating piston according to claim 1, wherein said the retaining part is made of a plastic.

7. The separating piston according to claim 1, wherein one of said guide part and retaining part comprises a receptacle for connecting to the other one of said retaining part and guide part.

8. The separating piston according to claim 7, wherein said guide part and retaining part are connectable to one another by one of positive engagement and frictional engagement.

9. The separating piston according to claim 8, wherein said receptacle is formed by a rotationally symmetrical receptacle opening of said guide part which is coaxial to a longitudinal axis of said separating piston; said retaining part additionally comprising a receptacle projection dimensioned for insertion into said rotationally symmetrical receptacle opening of said guide part.

10. The separating piston according to claim 8, wherein said receptacle is formed by a rotationally symmetrical receptacle projection of said guide part which is coaxial to a longitudinal axis of said separating piston; said retaining part additionally comprising a receptacle opening dimensioned for receiving said rotationally symmetrical receptacle projection.

11. The separating piston according to claim 9, wherein said receptacle projection is dimensioned for insertion into said receptacle opening with an interference fit.

12. The separating piston according to claim 10, wherein said receptacle projection is dimensioned for insertion into said receptacle opening with an interference fit.

13. The separating piston according to claim 2, wherein said the retaining part is made of a plastic.

14. The separating piston according to claim 3, wherein said the retaining part is made of a plastic.

15. The separating piston according to claim 4, wherein said the retaining part is made of a plastic.
